(19) United States
(12) Patent Application Publication
(10) Pub. No.: US 2009/0061850 A1
(43) Pub. Date: Mar. 5, 2009

(54) CORDLESS PHONE SYSTEM WITH DATA RETRIEVING CAPABILITY USING WIRELESS TECHNOLOGY

(75) Inventors: Man To LI, Hong Kong (CN); Kin Kwok LI, Hong Kong (CN); Wai Chung FUNG, Hong Kong (CN); Ming Fung LAM, Hong Kong (CN); Wing Hei AU, Hong Kong (CN)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CCT TECH ADVANCED PRODUCTS LIMITED, Hong Kong (CN)

(21) Appl. No.: 11/849,167

(22) Filed: Aug. 31, 2007

(51) Int. Cl. H04Q 7/20

(52) U.S. Cl. 455/426.1

(57) ABSTRACT

A cordless phone system 100 for performing data retrieval from a wireless network through a wireless phone is disclosed. The cordless phone system 100 comprises a phone base apparatus 110 and a handset apparatus 140. The phone base apparatus 110 comprises a communication interface 111 for coupling to a PSTN, a communication interface 122 for wirelessly communicating data through a communications network using a wireless network protocol, a communication interface 132 for wirelessly communicating with the handset apparatus 140 using a cordless telecommunications protocol, and a processing means 124, 134 or 180 coupled to the PSTN communication interface 111, the wireless network communication interface 122, and the cordless-telecommunications communication interface 132 for processing data communicated between the wireless network communication interface 122 and the cordless-telecommunications communication interface 132. The handset apparatus 140 is adapted to wirelessly communicate with the phone base apparatus 110 using the cordless telecommunications protocol data communicated between the phone base apparatus 110 and the wireless network and other data communicated between the phone base apparatus 110 and said PSTN.

### TECHNICAL FIELD

The present invention relates generally to wireless phone, and in particular, to data retrieval from a wireless network through a wireless phone.

### SUMMARY

Aspects of the present invention are provided for data retrieval functions, for example, audio streaming functions or internet radio, on a cordless phone for receiving data from the internet or network via a WLAN device.

According to an aspect of the present disclosure, there is provided a cordless phone system, comprising a phone base apparatus and a handset apparatus. The phone base apparatus comprises a communication interface for coupling to a PSTN, a communication interface for wirelessly communicating data through a communications network using a wireless network protocol, a communication interface for wirelessly communicating with the handset apparatus using a cordless telecommunications protocol, and a processing means coupled to the PSTN communication interface, the wireless network communication interface, and the cordless-telecommunications communication interface for processing data communicated between the wireless network communication interface and the cordless-telecommunications communication interface. The handset apparatus is adapted to wirelessly communicate with the phone base apparatus using the cordless telecommunications protocol data communicated between the phone base apparatus and the wireless network and other data communicated between the phone base apparatus and said PSTN.

According to another aspect of the present disclosure, there is provided a method of data communication for a cordless phone system having a phone base apparatus comprising a PSTN communication interface, a wireless network communication interface, and a cordless-telecommunications communication interface and a handset apparatus comprising a user interface. The method comprising the steps of receiving, at the phone base apparatus, data through the wireless network communication interface via a wireless network, processing, at the phone base apparatus, the received data for rendering at the handset apparatus, transmitting the converted data from the cordless-telecommunications communication interface of the phone base apparatus to the handset apparatus, and rendering, at the handset apparatus, the transmitted data and outputting the rendered data from the user interface.

### BRIEF DESCRIPTION OF THE DRAWINGS

Embodiments of the present invention are described with reference to the drawings in which:

FIG. 1A is a schematic block diagram of a cordless phone system according to an embodiment of the invention;

FIG. 1B is a schematic block diagram of a cordless phone system according to another embodiment of the invention;

FIG. 2 is a schematic block diagram of a wireless network communication module of a DECT phone base apparatus of FIG. 1A;

FIG. 3 is a schematic block diagram of a DECT module of a DECT phone base apparatus of FIG. 1A;

FIG. 4 is a schematic block diagram of the DECT handset of FIGS. 1A and 1B;

FIGS. 5A-5B are a flow chart for operation of data transfer from a content-providing server to a DECT phone base apparatus;

FIGS. 6A-6B are a flow chart for operation of data transfer from a content-providing server to a DECT handset via a DECT phone base; and

FIG. 7 is a flow chart for operation of handling incoming or outgoing call during data transfer.

### DETAILED DESCRIPTION

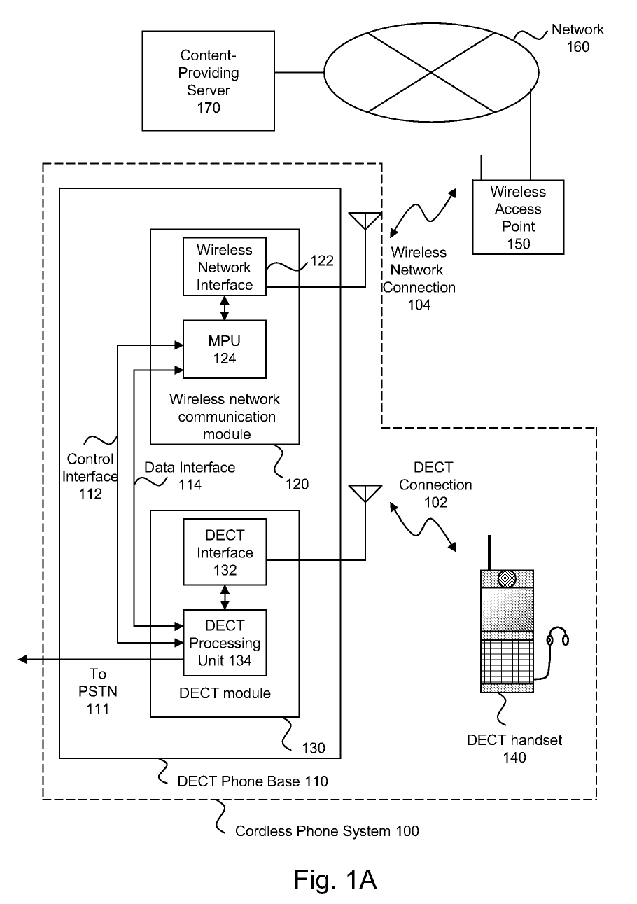

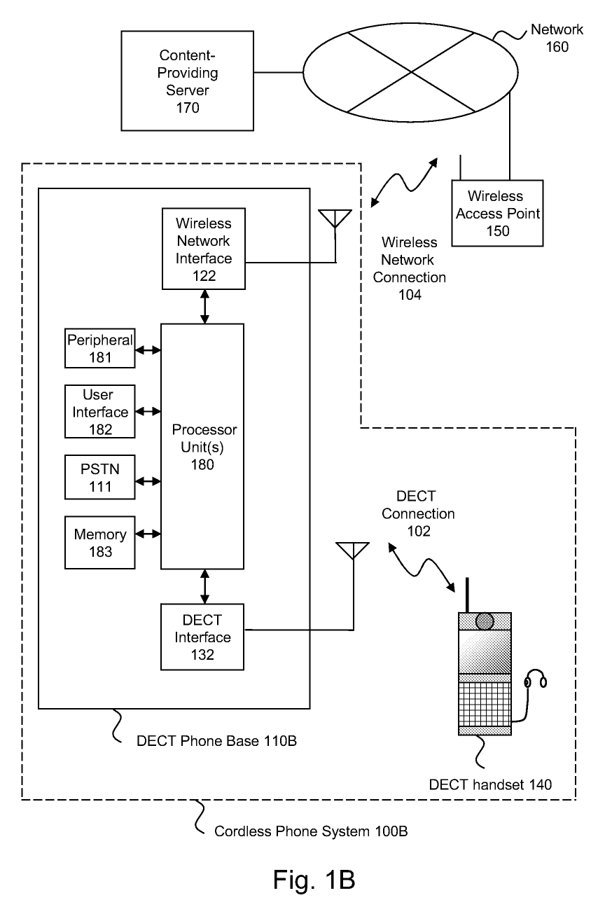

FIG. 1A shows a cordless phone system 100 in accordance with an embodiment of the invention and a wireless access point 150, via which the cordless phone system 100 can access a content-providing server 170.

The cordless phone system 100 comprises a phone base apparatus 110 and a DECT handset apparatus 140. The phone base apparatus 110 has at least three interfaces: a communication interface 111 (PSTN communication interface) for coupling to a PSTN (Public Switched Telephone Network), a communication interface 122 (wireless network communication interface) for wirelessly communicating data using a wireless network protocol, and a communication interface 132 (cordless-telecommunications communication interface, such as DECT) for wirelessly communicating with the handset apparatus 140 using a cordless telecommunications protocol. The phone base apparatus 110 also has at least a processing unit (an MPU 124 and/or a DECT processing unit 134 (processor unit(s) 180 in the case of a cordless phone system 110B of FIG. 1B) coupled to the interfaces 111, 122, 132 for processing data communicated between the wireless network communication interface 122 and the cordless-telecommunications communication interface 132. The handset apparatus 140 communicates with the phone base apparatus 110 using the cordless telecommunications protocol. The data communicated between the handset apparatus 140 and the phone base apparatus 110 includes data communicated between the phone base apparatus 110 and the wireless network, and data communicated between the phone base apparatus 110 and the PSTN.

The wireless network protocol of the wireless network connection 104 can be a Wireless Local Area Network (WLAN) protocol such as IEEE 802.11(g/b), also known as Wi-Fi. The wireless network protocol may be another protocol that can be used to access a content-provider server 170 via a network 160, such as Bluetooth, IrDA etc. The cordless telecommunications protocol may be the Digital Enhanced Cordless Telecommunications (DECT) protocol. DECT protocol is a protocol that can be used for wireless data transfers. DECT can be used for wireless communication between a home-type phone having a base unit typically having a landline (PSTN) connection and a cordless handset. Further, DECT utilizes a frequency range of 1920-1930 MHz in the US, and 1880-1900 MHz in Europe, enabling the wireless communication to operate without the interference from other radio communications found in common domestic environment such as Wi-Fi.

The handset apparatus 140 can receive a control command from a user to retrieve data from a remote source (for example a content-providing server 170) accessible from the wireless network 160 via the phone base apparatus 110 using the cordless telecommunications protocol of connection 102 and the wireless network protocol of connection 104. The handset apparatus 140 forwards the control command to the phone base apparatus 110 via the cordless telecommunications protocol.

The processing unit 124/134 (the processor unit(s) 180 in FIG. 1B) of the phone base apparatus 110 can convert data received by the wireless network communication interface 122 to a format that is suitable for a user interface of the phone base apparatus 110 or a user interface of the handset apparatus 140.

The handset apparatus 140 can render data that is received using the cordless telecommunications protocol for outputting by a user interface of the handset apparatus 140.

Hereinafter, the format conversion of the content data refers to conversion of the content data to a format suitable for outputting the data using a user interface of the phone base apparatus 110 or the handset apparatus 140. The format conversion may include such processing as decoding and encoding of multimedia format. The content data rendering refers to an operation to output, or present, the content data from the user interface, such as playing the multimedia data using a speaker or a display.

The processing unit 124/134 (the processor unit(s) 180 in FIG. 1B) of the phone base apparatus 110 can convert content data for outputting by the user interface of the handset apparatus 140 by downsizing the data for rendering at the handset apparatus 140. The content data is received by the wireless network communication interface 122 and forwarded from the cordless-telecommunications communication interface 132.

The processing unit 124/134 (the processor unit(s) 180 in FIG. 1B) can also detect a request for an incoming or an outgoing call through the PSTN communication interface 111 while performing communication using the wireless network communication interface 122. When the request is detected, the processing unit 124/134 (the processor unit(s) 180 in FIG. 1B) can stop the wireless communication using the wireless network communication interface 122.

Referring to the schematic block diagram of FIG. 1, the cordless phone system 100 comprises a phone base apparatus 110, for example, a DECT phone base, and one or more handset apparatuses 140, for example, DECT handset(s).

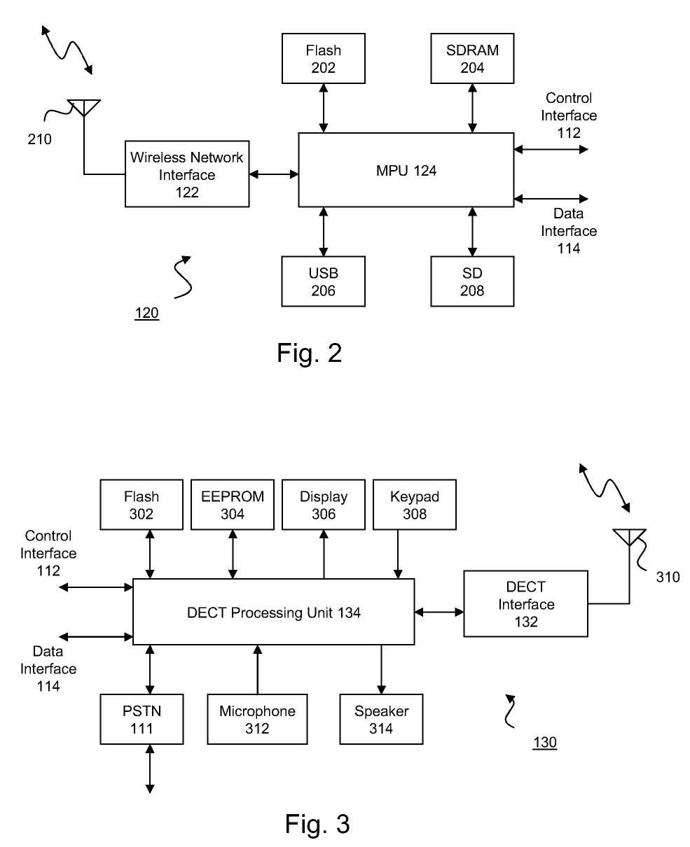

The DECT phone base apparatus 110 is a host system that interacts with user and controls a wireless network communication module 120 to retrieve data from a content-providing server 170. The module 120 is described hereinafter in greater detail with reference to FIG. 2. The DECT phone base 110 has two communication modules 120, 130 each designed for a different wireless communications protocol. The wireless network communication module 120 is designed for communication using a wireless network communication protocol, for example a Wi-Fi protocol, and provides a data retrieving capability for the DECT phone base apparatus 110, such as audio data, and/or image data, etc, from the content-providing server 170 through the network 160. The DECT communication module 130 is designed for communication using the DECT protocol.

The wireless network communication module 120 has a wireless network interface 122 for communication with an external wireless access point 150 via the wireless network connection 104. Data received by or data to be transmitted from the wireless network interface 122 is processed by a main processor unit (MPU) 124, for example for MAC (Media Access Control) layer processing. The data may include content data or control data such as a request message or a response message.

For content data, the MPU 124 typically converts the content data into a format that can be output (e.g. played, displayed) by the DECT phone base 110 or the DECT handset 140. The downsizing of the content data to a data size suitable for outputting by the DECT handset apparatus 140, when necessary, is also typically performed by the MPU 124. This downsizing allows the DECT handset apparatus 140, which typically has hardware/software resources smaller than that of the DECT phone base 110, to output content data with the available resources.

The MPU 124 is coupled to the wireless network interface 122 within the module 120 and may be an ARM9 MPU. When data is received by the wireless network interface 122, MPU 124 processes the data received in wireless network protocol to obtain content data or control data and forward the obtained data to the processor 134 of the DECT module 130. When control data (or content data) is received from the DECT processor 134 for transmission from the wireless network interface 122, the wireless network communication module 122 modulates the data into the wireless network protocol and then transmits the data via the wireless network connection 104. Likewise, the wireless network communication module 122 receipts and convert data for MCU 124 to translate into a proprietary communication protocol used internally in the DECT phone base 110 such that the data can be communicated to and processed by the DECT module 130.

The content data communicated using the wireless network connection 104 is transferred between the wireless network communication module 120 and the DECT module 130 in the proprietary communication protocol using a data interface 114. Control data for wireless network communication is transferred between the wireless network communication module 120 and the DECT module 130 using a control interface 112. The control interface 112 may be an interfaces such as UART (universal asynchronous receiver/transmitter), I²C™ (Inter-integrated circuit), SPI (Series Peripheral Interface), etc. Physically, the data interface 114 and the control interface 112 can be integrated into one bus or separated into buses, and these interfaces can be analog or digital. Control data for a user interface, such as a request for content data, is typically received or generated by the DECT processing unit 134 and transmitted to the wireless network communication module 120 through the control interface 112. The wireless network communication module 120 also performs the protocol conversion between the proprietary protocol used internally in the DECT phones base 110 and common protocols used in the networks (e.g., HTTP for obtaining pictures, streaming audio or RTSP for streaming video, etc).

The DECT module 130 has a DECT interface 132 for communication with the DECT handset 140 through a DECT connection 102. Data received from or transmitted to the DECT handset 140 is demodulated or modulated in the DECT protocol by the DECT interface 132. For data to be output by the DECT phone base 110, the DECT processing unit 134 performs the rendering of the content data and outputs the rendered data through the user interface (e.g. display, speaker) of the DECT phone base 110. The DECT processing unit 134 may also perform the downsizing of the content data to a suitable size for the DECT handset 140, as an alternative to MPU 124 performing the downsizing as described above. The DECT processor 134 is also coupled to a PSTN interface 111 for handling communication using a PSTN network. Incoming and outgoing PSTN communication is also processed by the DECT processor 134. The DECT processor 134 also receives input from the user via the user interface and processes the input by, for example, forwarding the input request to the content-providing server 170.

The DECT handset 140 communicates with the DECT interface 132 of the DECT phone base 110 via the DECT connection 102. The DECT handset 140 renders the content data forwarded by the DECT phone base 110 and outputs the rendered data using a user interface of the DECT handset 140. The smaller resources of the DECT handset 140 may be due to smaller processing capabilities, or limitation of the user interface such as smaller display or output interface with less functional capabilities.

A wireless access point 150 that communicates with the wireless network interface 122 of the DECT phone base 110 is a wireless LAN base station, for example. The DECT phone base 110 can access the content-providing server 170 through the wireless access point 150, which can access the server 170 via a network 160 such as the internet. Alternatively, the content-providing server 170 can be built into the same apparatus as the wireless access point 150 or otherwise accessible via the wireless access point 150. The data to be retrieved from the content-providing server 170 may be in a variety of forms, such as pictures, audio and/or video data in a streaming format, etc.

FIG. 1B shows the cordless phone system 100B according to another embodiment of the invention. For the sake of brevity, the description of like numbered features from FIG. 1A is not repeated here. Instead, reference is made to the foregoing description of these features. This system 100B differs from the system 100 of FIG. 1A in that the wireless network communication module and DECT module of FIG. 1A are integrated into single-chip architecture in the DECT phone base 110B. A processor unit 180, or a set of processor units, performs functions equivalent to those of the MPU 123 and the DECT processing unit 134 of FIG. 1A as described above. The processor unit(s) 180 is coupled to the wireless network interface 122, the DECT interface 132, the PSTN interface 111, a memory unit 183, a user interface 182 and other peripherals 181. The functionality of the DECT phone base 110B is equivalent to that of FIG. 1A.

FIG. 2 shows a schematic block diagram of the wireless network communication module 120 of the DECT phone base 110 of FIG. 1A. The wireless network communication module 120 has an antenna 210 connected to the wireless network interface 122, memory means such as a flash memory 202, an USB port 206 and/or an SD port 208 for connecting with an external memory device such as an SD (secure digital) memory card, and an SDRAM 204, each coupled to the MPU 124. The interface 122 is also coupled to the MPU 124. The MPU 124 processes control data and contents data via interfaces 112, 114 of FIG. 1A, respectively, including conversion of content data into format(s) that can be processed by the DECT module 130 or the DECT handset 140, and downsizing of content data for the DECT handset 140 of FIG. 1A. The flash memory 202 is configured to store the firmware for realizing the functionalities of the module 120 executed on the MPU 124, such as data format conversion and data downsizing. During the processing of data, the data can be temporarily stored in the SDRAM 204. Both data and instructions for the MPU 124 may be stored in the SDRAM 204. The MPU 124 may also store the data in the memory unit such as the flash memory 202 and an SD card through the SD port 208 via the address and data bus, or through the USB port 206 in an external device.

FIG. 3 shows the DECT module 130 of the DECT phone base 110 of FIG. 1A in more detail. An antenna 310 is connected to the DECT interface 132. The DECT module 130 also has a flash memory 302, an EEPROM 304, a user interface for output such as a display 306 and/or a speaker 314, a user interface for input such as a keypad 308 and/or a microphone 312, and a PSTN interface 111 each coupled to a DECT processing unit 134.

The flash memory 302 preferably stores the firmware to implement the functionalities of the DECT module 130, such as for retrieving data via an interface 114 from the content-providing server (not shown, as in FIG. 1A), rendering the received data to output from the user interface of the DECT phone base 110, and downsizing the received data before forwarding the data to the DECT handset (not shown, as in FIG. 1A) if this is also performed by the DECT processing unit 134. The DECT processing unit 134 also has a control interface 112. The functionalities for data retrieval can include processing of user input through the user interface of the DECT phone base 110 or the DECT handset (not shown, as in FIG. 1A), forwarding of user input, for example directed to the content-providing server (not shown, as in FIG. 1A), and outputting messages such as prompts for the user. User data such as the data received from the content-providing server (not shown, as in FIG. 1A) may be stored in the flash memory 302. The keypad 308 typically comprises a set of number keys, navigation key(s) and soft function key(s), whose input can be interpreted by the DECT processing unit 134, for example, as confirmation, cancellation, etc., according to the program that is being executed, such as for prompting the user to input a certain command. The number keys can also be soft function key(s) for inputting alphabetic characters or symbols, for example depending on the number of consecutive selection of the key.

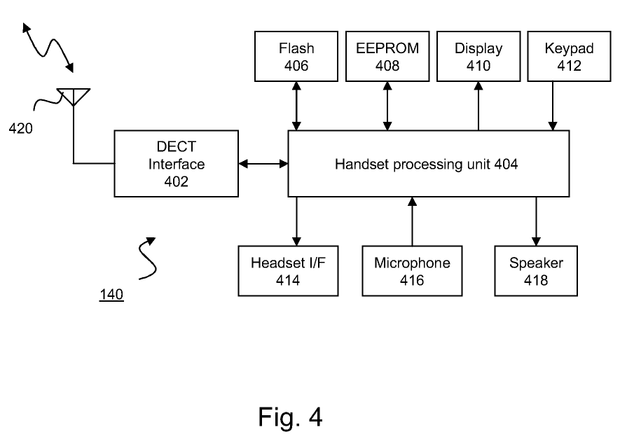

FIG. 4 shows a schematic block diagram of the DECT handset 140 of FIGS. 1 and 1B in more detail. The DECT handset 140 has a DECT interface 402 connected to an antenna 420 for communication with the DECT interface 132 of the DECT phone base apparatus 110. The DECT interface 402 is connected to a handset processing unit 404. The handset processing unit 404 is coupled to a flash memory 406, an EEPROM 408, user interface for output such as a display 410, a speaker 418 and/or an interface 414 for headphone or earphone(s), and a user interface such as a keypad 412 and/or a microphone 416.

The flash memory 406 stores the firmware for realizing the functionalities of the handset 140, such as for retrieving data from the content-providing server 170 and rendering the received data to output from the user interface of the DECT handset 140. Functionalities for data retrieval further include processing of user input through the user interface of the DECT handset 140, forwarding of user input, for example to the content-providing server 170, and outputting messages such as prompts for the user. User data such as the data received from the content-providing server 170 can be stored in the flash memory 402. The keypad 412 typically comprises a set of number keys, navigation key(s) and soft function key(s), such as found on a typical mobile phone.

The display 410 may comprise an LCD display to display an image (still or video) received by the wireless network interface 122 from the content-providing server 170 and also to display prompts, menus, lists, and other messages for the user. The menus or lists can be used to allow the user to choose an item from the menus or lists using the navigation key(s) and a confirmation input. The speaker 418 can be used to output audio data received by the wireless network interface 122 from the content-providing server 170, on its own or in combination with the image. Other forms of user interface can also be adopted. Microphone 416 can be used for inputting user commands, which can be voice-recognized and interpreted by the DECT processing unit 134 and/or DECT processor 404 to convert into a format that can be used by the relevant apparatus.

The speaker 418 and the microphone 416 can configured so that they can be used both as a user interface for the wireless network data and for voice communication using the PSTN. Advantageously, the speaker 418 can be configured to be operable in a hands-free mode.

The processor 404 also has the functionalities of encoding and digitizing analog voice signals input from the microphone 416 and forwarding such voice signals through the PSTN interface 111 of the DECT phone base 110 to the PSTN network or through the wireless network interface 122 onto the network 160.

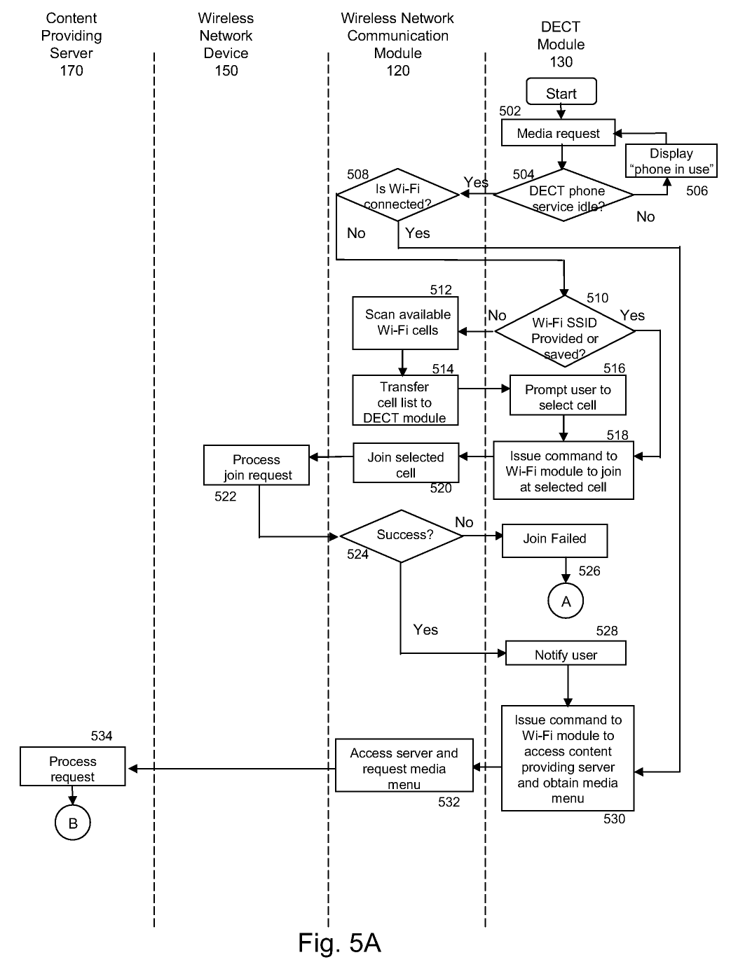

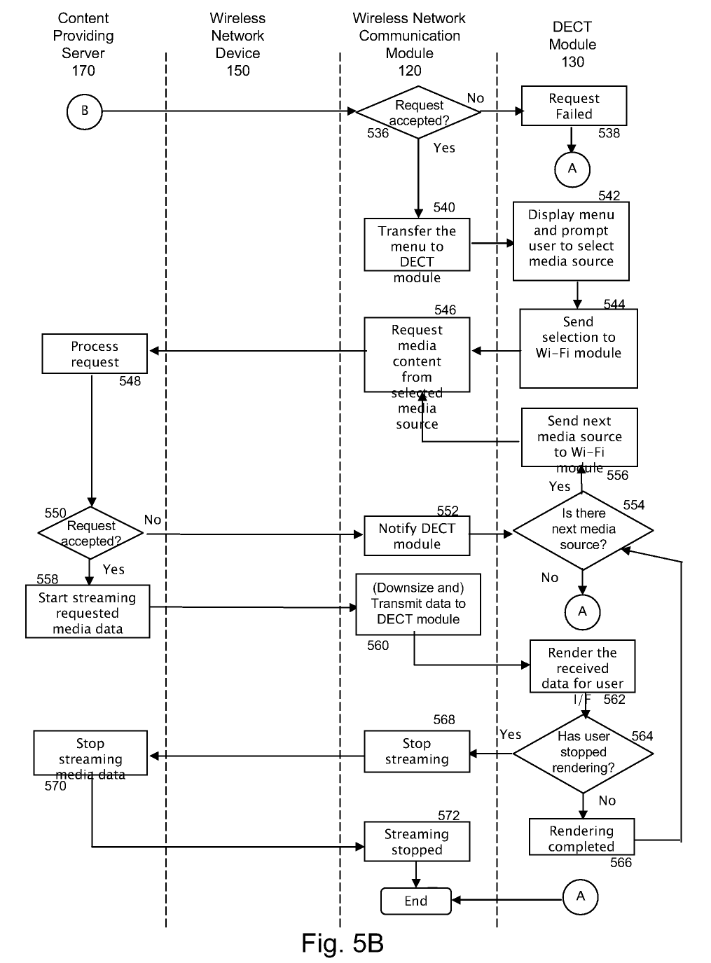

FIGS. 5A-B show the process of transferring data from a content-providing server 170 to the DECT phone base apparatus 110, in which the data is converted and rendered and output from the user interface of the DECT phone base 110. The following description referring to FIGS. 5-7 assumes the configuration of the DECT phone base 110 shown in FIG. 1A. However, it would be apparent to those skilled in the art in the light of this disclosure that the same operation can be performed using the DECT phone base 110B shown in FIG. 1B. The steps performed by the wireless network communication module 120 and the DECT module 130 for the DECT phone base 110B can be combined with appropriate alteration, such as omitting communication between the modules 120 and 130 of FIG. 1A.

Referring to FIG. 5A, when a media request is received from a user (step 502), the processing unit 134 of the DECT module 130 determines if DECT phone service is in an idle state (504). If the DECT phone is in a busy state (No), for example, with the processing of a media request or handling a PSTN communication, the DECT phone base 110 notifies “phone in use” message on the display 306 (506). The notification of this and any other message for the user can also be done in other manners, such as by using the speaker 314. Processing then continues from step 506 at step 502. If the DECT phone service is idle in step 504 (Yes), the media request is to be forwarded to the wireless network communication module 120 (504). Processing continue at step 508 which checks if the wireless network communication is connected. As shown in FIGS. 5A and 5B, vertical dashed lines indicate where processing is performed in the content-providing server 170, the wireless network device 150, the wireless network communication module 120, the DECT module 130, and the DECT handset 140 (from left to right horizontally).

If the wireless network communication module 120 is not already connected to an outside wireless access point 150 at step 508 (No), then processing continues in the flow path of steps 510-528 to establish a connection. If the DECT module 130 is notified by the wireless network communication module 120 that the wireless network communication module 120 is not connected (No), the DECT module 130 determines in step 510 whether or not a SSID (service set identifier) for the wireless network communication is provided or saved. The SSID is an ID that is necessary for wireless network packet communication and is typically provided through user input or user selection. If the SSID doesn't exist (NO), the wireless network communication module 120 scans available wireless network cells (wireless access points 150) that are broadcasting SSIDs (512) and transfers a list of available cells (SSIDs) to the DECT module 130 (514). Displaying the cell list on the display 306, the DECT module 130 prompts the user to select a cell (516). In step 518, the DECT module 130 issues a command to the wireless network communication module 120 to join at the selected cell by connecting to a wireless access point with the selected SSID, or connect to a wireless access point with the existing SSID (518). A request to join the selected cell transmitted from the wireless network communication module 120 via the wireless network connection 104 (520) is processed by the wireless access point 150 having the selected SSID (522). If a connection request fails in step 524 (No), the wireless network communication module 120 notifies the DECT module 130 that the join was failed, and the operation for data retrieval is ended (526). If a connection is successfully established, the DECT module 130 notifies the user (528).

After step 528, or step 508 if there is an existing connection, the DECT module 130 issues a command to the wireless network communication module 120 to access the content-providing server 170 and to obtain a media menu (530). In step 532, the wireless network communication module 120 accesses the content-providing server 170 and transmits a request for a media menu. The server 170 processes the received request (534). In step 536, if the request fails (No), the DECT module 130 acknowledges the failure (538) and the operation for data retrieval is ended.

In step 536, if the request was accepted and the media menu is received from the server 170 (Yes), the wireless network communication module 120 transfers the received media menu to the DECT module 130 (540). The DECT module 130 displays the media menu and prompts the user to select a media source (542). The DECT module 130 sends the information about the selected media source to the wireless network communication module (544), which in turn transmits a request for media content from the selected media source to the server 170 (546). If the request is processed (548) but is not accepted by the server 170 (No) in step 550, to the wireless network communication module 120 notifies the DECT module 130 (552). In step 554, if there is no next media source selected (by the user or otherwise) in the media menu provided in step 542 (No), the operation for data retrieval is ended. If there is a next media source (Yes) at step 554, the DECT module 130 sends the information about the next media source to the wireless network communication module 120 (556) to repeat steps 546 to 550.

If the request for media content is accepted (Yes) in step 550, the server 170 starts transmitting/streaming the requested media content to the wireless network communication module 120 of the DECT phone base 110 (558). The wireless network communication module 120 converts the format of the media content data to a format playable by the DECT module 130 and transmits the converted data to the DECT module 130 (560). The wireless network communication module 120 may downsize the media content data as required in step 560. The DECT module 130 renders the data received from the wireless network communication module 120 to output the rendered data for the user (562). The output takes the form of, for example, displaying of the picture/video on the display 306 or the playing of the audio data from the speaker 314.

If the requested media data is not a data for streaming, the operation is completed (566) when the whole of the media data is received, rendered and outputted by the DECT module 130, processing continues at and step 554 to determine if there is a next media source.

If the requested media data is data for streaming, there may be a situation where the user inputs a command to stop the data streaming (564) and the rendering at the DECT module 130 is stopped (Yes). If this happens, a request message to stop streaming is transmitted to the server 170 via the wireless network communication module 120 (568). The streaming by the server 170 is then stopped (570) and when this is confirmed at the wireless network communication module 120, the operation is completed (572).

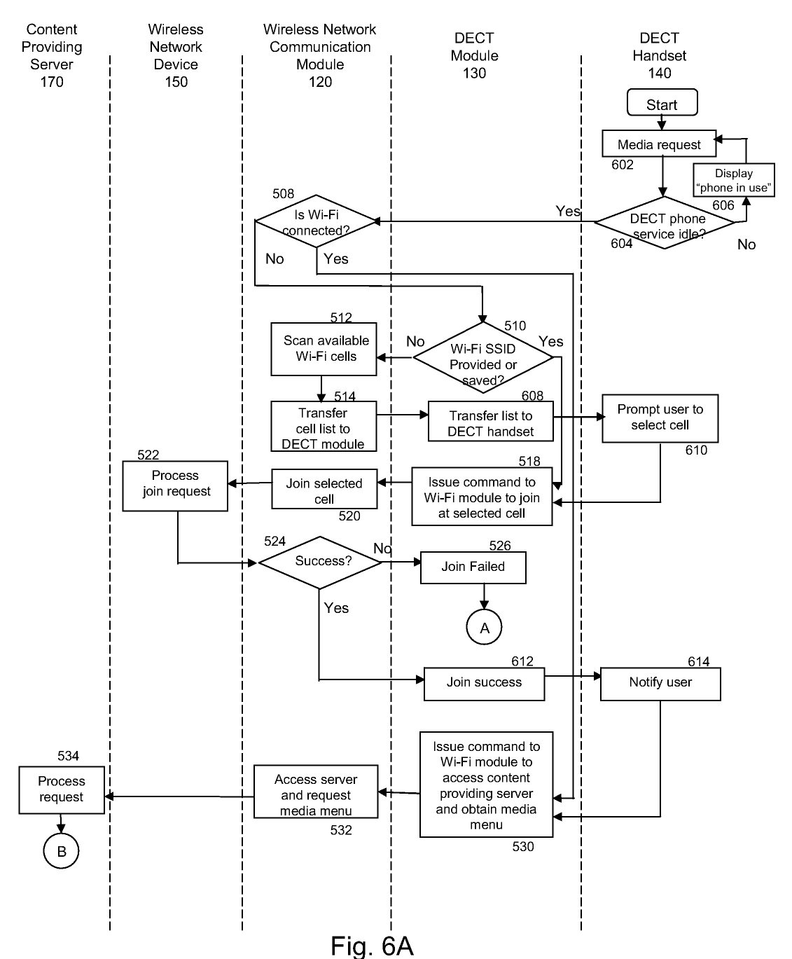

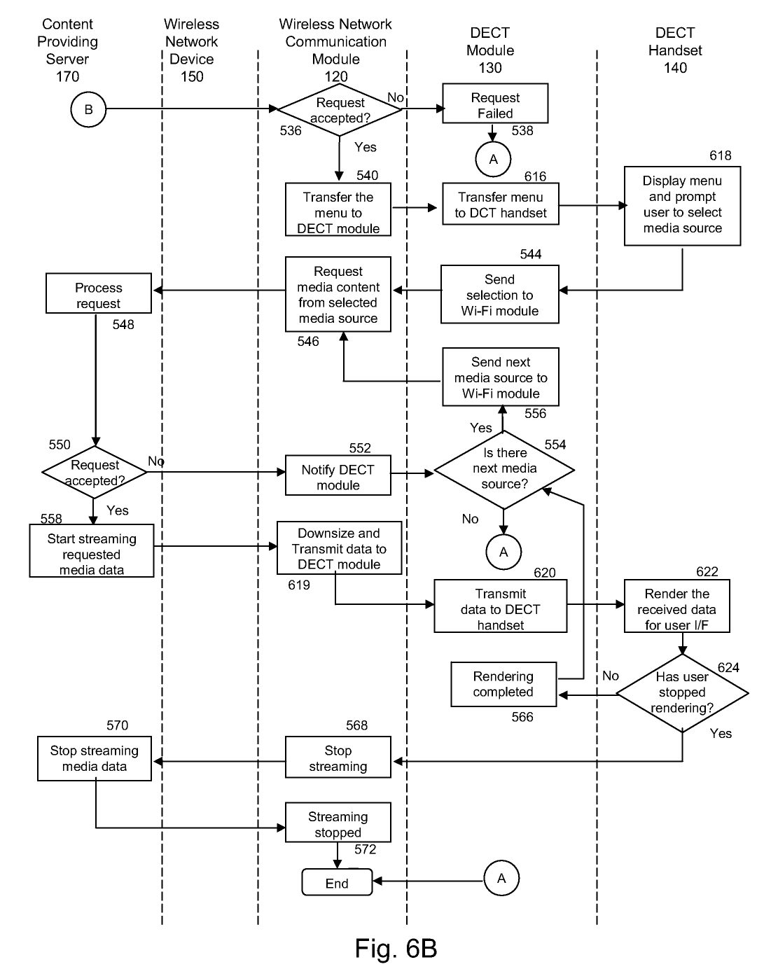

FIGS. 6A-B show a process of transferring data from the content-providing server 170 to the DECT handset 140 via the DECT phone base apparatus 110, in which the data is rendered by the DECT handset 140 and output from the user interface of the DECT handset 140.

The operation illustrated in FIGS. 6A-B differs from the operation of FIGS. 5A-B in that the user interface used for input of the user commands and output of the data and information for the user is the user interface of the DECT handset 140. Steps in variant to the operation of FIGS. 5A-B are described below in relation to FIGS. 6A-B. Where the same steps are performed in FIGS. 6A and 6B as in FIGS. 5A and 5B, the same reference numerals are used in FIGS. 6A and 6B, and the description is not repeated for brevity's sake.

Steps 602-606 of FIG. 6A of receiving an input of media request, determining whether the DECT phone is in use, and displaying the message “phone in use” on the display 410 of the DECT handset are performed by the handset processing unit 404 of the DECT handset 140, whereas the equivalent steps 502-506 of FIG. 5A are performed by the DECT module 130. From step 604, the configuration of steps 508, 510, 512, 514, 518, 520, 522, 524 and 526 are the same as in FIG. 5A. Similarly, steps 530, 532 and 534 are the same as in FIG. 5A. The media request is transmitted from the DECT handset 140 to the wireless network communication module 120 via the DECT module 130.

The media request may contain information to declare the originating apparatus of the request, or the target apparatus where the requested media is to be rendered and output (i.e. the DECT phone base 110 or the DECT handset 140). The MPU 124 can use this information for downsizing the media data as necessary. The resource constraints that necessitate downsizing of the media data include capabilities of the rendering apparatus (e.g. the size of the display, the maximum sampling rate accepted, etc) or the communication capacity of the DECT connection 102 between the DECT phone base 110 and the DECT handset 140 (e.g. for video streaming). Specifics of resource constrains may be stored in the wireless network communication module 120 or the DECT module 130 in advance, as a part of the firmware for implementing the functionalities of the DECT phone base 110. To determine the necessity of downsizing, and to perform the downsizing, the processor (e.g. the MPU 124) refers to the constraints information associated with the outputting apparatus, and downsizes the media data accordingly. Constraints which may vary, such as available bandwidth, can be determined or enquired by the processor as necessary.

Alternatively, the downsizing may be performed in two stages by the MPU 124 and the DECT processing unit 134. For example, the MPU 124 performs downsizing of the media data to an extent sufficient at least for outputting by the DECT phone base 110. If the downsized media data is still not suitable for transmission to the DECT handset 140 or for outputting from the DECT handset 140, then the DECT processing unit 134 can perform further downsizing. For this arrangement, information necessary for the downsizing by the MPU 124 irrespective of the outputting apparatus can be stored in the memory device of the wireless network communication module 120, and information necessary for downsizing for the DECT handset 140 can be stored in the memory device of the DECT module 130.

Messages for the user such as the prompt to select a wireless network cell (610), a notification of establishment of a connection (614) and a prompt to select a media source from the media menu (618) are output by the DECT handset 140. Such messages are output by the DECT handset 140 after the messages and other information such as the cell list and the media menu are forwarded to the handset 140 from the DECT module 130 (608, 612, 616) in continuation from step 514, success of joining a cell (Yes) in 524 and step 540, respectively. After steps 610, 614 and 618, processing continues at steps 518, 530 and 544, respectively.

After step 558, the wireless network communication module 120 performs downsizing and format conversion of the media content data to a format playable by the DECT handset 140 in step 619. The downsized and converted media content data is then transmitted from the wireless network communication module 120 to the DECT module 130 (619), which subsequently forwards the converted data to the DECT handset 140 in step 620. The handset processing unit 404 of the DECT handset 140 performs the rendering of the content data received from the DECT module 130 (620) for outputting it with the user interface of the DECT handset 140 (622). Since the rendering is performed in the handset 140 and any command to stop the rendering is expected to be received by the handset 140, whether the user has stopped rendering is determined by the DECT processing unit 404. If the user inputs a command to stop rendering (Yes) in step 624, the request message to stop streaming is transmitted from the DECT handset 140 to the wireless network communication module 120 and processing continues at step 568. If the rendering of the data is completed (No) in step 624, then the completion is notified by the DECT hand set 140 to the DECT module 130, and processing continues at step 564.

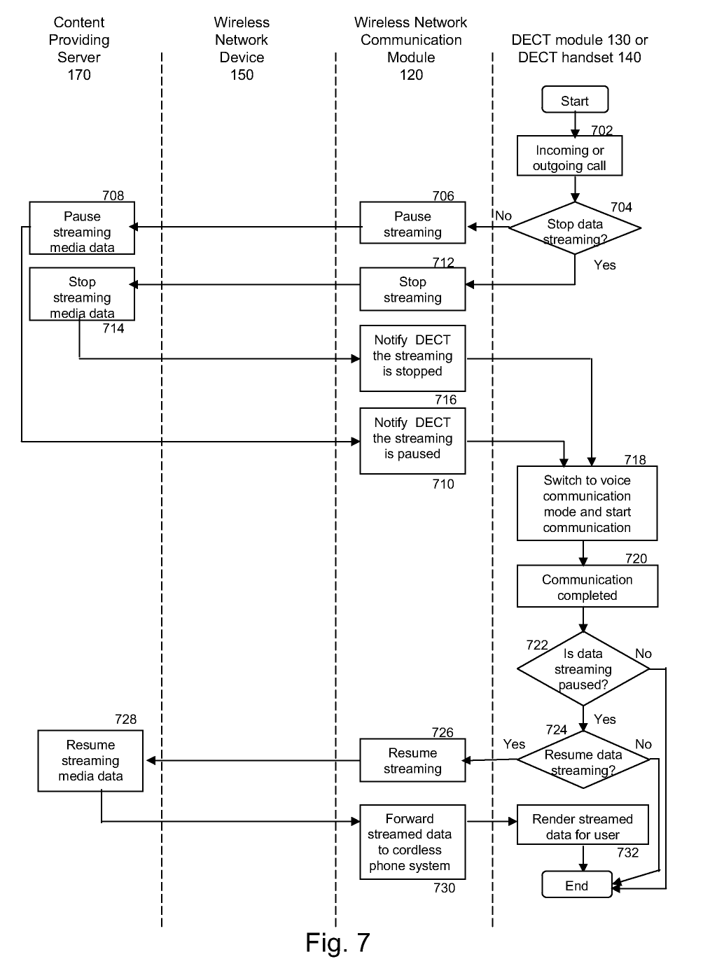

FIG. 7 illustrates the handling of an incoming or outgoing call by the DECT module 130 or the DECT handset 140 during data transfer. The recipient of the data transfer may be either of the DECT phone base apparatus 110 or the DECT handset 140 of the cordless phone system 100.

The operation of FIG. 7 may occur while steps 562 and 622 of FIG. 5B and 6B, respectively, either stops the streaming/transmitting of data or pauses the streaming to resume later (704) when a request for an incoming or an outgoing call for the PSTN network is detected (702). The detection of the new call for the PSTN network and all steps shown in the right-most column of FIG. 7 can be performed by either the DECT module 130 or the DECT handset 140, depending on which of the two components the streaming data or the transmitted data is directed to, and, in the case of an outgoing call, where the request for an outgoing call originates. In the case of an incoming call, the initial detection (702) occurs at the DECT module 130. FIG. 7 is described with reference to a case where the new incoming/outgoing PSTN call is detected at the DECT module 130, and the streaming media data is directed to the DECT handset 140.

In step 704, the operation to stop (end) or pause the streaming/transmission can be selected in a variety of manners. The cordless phone system 100 may allow the user to input his/her preferences in advance regarding which operation is to be selected in the event a streaming/transmission of data is interrupted by a PSTN call. Alternatively, it may be determined using information of the content data being transferred, such as the priority of the content data, size of the whole of the content data, the size of the content data that has already been transferred, or is yet to be transferred or other attributes of the content data.

According to the selected operation, the wireless network communication module 120 transmits a message to either pause or stop the streaming to the content-providing server 170 (706 or 712). The server 170 either pauses or stops the streaming according to the message received from the wireless network communication module 120 (708 or 714) and reports the processing to pause or stop the streaming to the cordless phone system. Upon receiving the report, the wireless network communication module 120 notifies the pausing or the stopping of the data streaming/transmission to the DECT module 130 and the DECT handset 140 (710 or 716). If the data streaming/transmission is stopped, the DECT handset 140 ends the operation of receiving, rendering and outputting of the data. If the data streaming/transmission is paused, the DECT handset 140 proceeds to a stand-by status to later resume the operation of receiving, rendering and outputting of the data.

The DECT module 130 switches to a voice communication mode and starts communication for the new call using the PSTN interface 111 (718). If the data streaming/transmission is paused, the DECT module 130 registers the information of the data streaming/transmission that is paused for the new PSTN call. When the PSTN communication is completed (720), the DECT module 130 determines whether or not the data streaming/transmission interrupted by the PSTN was paused (722). If the data streaming/transmission was stopped (No) in step 722, or is not to be resumed (No) in step 724, the operation of FIG. 7 for coordinating a wireless network data transmission and a PSTN communication is ended. If streaming was paused in step 722 (Yes), it determines whether or not the paused streaming/transmission is to be resumed (724). If the data streaming/transmission is to be resumed (Yes) in step 724, a request to resume is transmitted to the content-providing server 170 via the wireless network communication module 120 (726). After resuming the data streaming/transmission (728), the operation returns to the processing that was in place before it was interrupted by the PSTN call in step 702, i.e. the streamed data is forwarded to the cordless phone system (730), and the streamed data is rendered for the user (732).

In a case where the data streaming/transmission was paused, when the end of the PSTN communication is determined by the DECT module 130, the DECT module may notify the end of the PSTN communication to the DECT handset 140 for the DECT handset 140 to determine whether or not to resume the streaming (724). This decision can be made, for example, by notifying the user of the DECT handset 140 the end of the interrupting PSTN call and prompting the user to input if he or she wishes to resume the data streaming/transmission. Alternatively, the DECT module 130 may notify the DECT handset 140 of the end of the PSTN call but determine the resuming of the data streaming/transmission, for example, based on a pre-set preference. This allows the DECT handset 140 and its user to resume the data reception without the need for further operation from the handset 140 or the user, by simply waiting for the data streaming/transmission to resume.

The above description assumes that the data streaming/transmission is directed to the DECT handset and the DECT module 130 first detects the new PSTN call (e.g. an outgoing call originating at the DECT phone base 110 or an incoming call), but other combinations are also possible. If the component which detects the new PSTN call and to which the data streaming/transmission is directed to are the same, then all of the steps of the right-most column of FIG. 7 can be performed in that same component (either the DECT module 130 or the DECT handset 140). If the data streaming/transmission is directed to the DECT module 130 and a new outgoing originates at the DECT handset 140, the detection of a new call (702) is notified to the DECT module 130 and the rest of the operation can be the same as if the new call originated at the DECT module 130.

The DECT handset 140 can be used as a remote controller for inputting user commands, even when the data output is desired to be performed by the DECT phone base 110. In such a scenario, prompts, menus, lists, commands, etc. are exchanged between the wireless network communication module 120 and the DECT handset 140 and inputted/outputted at the handset 140, while the received data is transmitted only as far as to the DECT module 130. The received data can be rendered and output at both the DECT phone base 110 and the DECT handset 140. In this case, the MPU 124 may downsize the original received data into different sizes for the DECT module 130 and the DECT handset 140 according to the resource constraints of the respective components.

The following are some examples of the data processing performed in relation to the streaming data or transmitted data.

The first example is an internet radio case where an audio data is transmitted to the cordless phone system 100 as a MP3™ streaming data using HTTP protocol. The MP3™ streaming data is transmitted from the content-providing server 170 to the wireless network communication module 120 using HTTP protocol, which is then processed by the MPU 124. The MPU 124 decodes the MP3™ to obtain analog data or digital data, depending on the design of the original data.

If the decoded data is an analog data, the analog data is sent to the DECT module 130 as an analog input, for example, as a PSTN, MIC, auxiliary signal, etc. If the decoded data is a digital data, the MPU adjust the sampling rate of the decoded signal to a sampling rate that the current DECT module 130 accepts as necessary. For example, the MPU down-converts the digital data if the original sampling rate exceeds the capability of the DECT module 130 or the DECT handset 140. When the decoded signal is ready, the MPU 124 notifies the DECT module 130 and transmits the decoded signal to the DECT module 130. If the audio streaming is directed to the DECT phone base 110, the DECT module 103 outputs the audio data to the speaker 314. If the audio streaming is directed to the DECT handset 140, then the audio data is forwarded to the DECT handset 140 using the DECT connection 102 and then outputted to the speaker 418 of the handset 140.

Another example is a case where the transmitted data is a picture data. The MPU 124 receives the picture data by HTTP protocol, FTP protocol, etc. The MPU 124 decodes the picture data if the data is compressed, and resizes the picture according to the hardware/software resources of the receiving component. The target size of the resizing depends on, for example, the resolution of the display (306 or 410), (e.g., 128×128) of the DECT phone base 110 or the DECT handset 140 to which the data is directed to. The processed picture is transmitted to the DECT module 130 (and then to the DECT handset 140) as raw data. The DECT processing unit 134 or the handset processing unit 404 then renders the raw data into displayable format and displays it on the display 306 or 410.

The downsizing of the picture data becomes necessary when the target component does not have enough processing power or bandwidth to process or display the original picture, or in the case of the transmission to DECT handset 140, if the DECT connection 102 does not have enough bandwidth to transmit the data.

A streaming of a video data can also be processed in a manner similar to that for a picture data described above.

Other possible applications of the present application include: web browser text message, instant messenger, video conference, radio receiving, wallpaper downloading, mp3 downloading, mp3 playing, mpeg4 downloading, mpeg4 playing, file exchange (uploading/downloading files between the handset and the internet), etc.

Whilst the above description only includes the downsizing of content data for rendering by the DECT handset 140, it is also possible to downsize the content data for rendering by the DECT module 130. Thin may be necessary when the content data obtained from the content-providing server 170 is intended for rendering by apparatus with much larger processing capacity. In this case, the MPU performs downsizing of the content data in step 560 in FIG. 5B for the purpose of outputting data to the user interface of the DECT phone base 110. Further, if the same content data is to be presented to the user from the DECT handset 140, then the MPU may apply the same degree of downsizing or greater degree of downsizing (i.e. the downsized content data is smaller) for the content data for the DECT handset 140.

The system and the method describe herein, and/or shown in the drawings, are presented by way of example only and are not limiting as to the scope of the invention. Unless otherwise specifically stated, individual aspects and components of the system and the method may be modified, or may be substituted by equivalents without departing from the scope and spirit of the invention.

1. A cordless phone system, comprising:
a phone base apparatus including:
a communication interface for coupling to a PSTN;
a communication interface for wirelessly communicating data through a communications network using a wireless network protocol;
a communication interface for wirelessly communicating with a handset apparatus using a cordless telecommunications protocol;
a processing means coupled to said PSTN communication interface, said wireless network communication interface, and said cordless-telecommunications communication interface for processing data communicated between said wireless network communication interface and said cordless-telecommunications communication interface; and
a handset apparatus for wirelessly communicating with said phone base apparatus using said cordless telecommunications protocol data communicated between said phone base apparatus and said wireless network and other data communicated between said phone base apparatus and said PSTN.

2. The cordless phone system according to claim 1, wherein said handset apparatus is adapted to receive a control command for retrieving data from a remote source accessible from said wireless network via said phone base apparatus using said cordless telecommunications protocol and said wireless network protocol and to forward said control command to said phone base apparatus via said cordless telecommunications protocol.

3. The cordless phone system according to claim 1, wherein said processing means of said phone base apparatus is adapted to convert data received by said wireless network communication interface to a format suitable for a user interface of said phone base apparatus or a user interface of said handset apparatus.

4. The cordless phone system according to claim 1, wherein said handset apparatus is adapted to render data received using said cordless telecommunications protocol for outputting by a user interface of said handset.

5. The cordless phone system according to claim 4, wherein said processing means of said phone base apparatus is adapted to convert content data for outputting by said user interface of said handset received by said wireless network communication interface and forwarded from said cordless-telecommunications communication interface by downsizing said content data for rendering at said handset apparatus.

6. The cordless phone system according to claim 1, wherein said processing means of said phone base apparatus is adapted to detect a request for an incoming or an outgoing call through said PSTN communication interface while performing communication using said wireless network communication interface.

7. The cordless phone system according to claim 6, wherein said processing means is adapted to stop or pause said communication using said wireless network communication interface when said request is detected.

8. The cordless phone system according to claim 1, wherein said wireless network protocol is at least one of a wireless local area network (WLAN) protocol, Bluetooth protocol, and an IrDA protocol.

9. The cordless phone system according to claim 1, wherein said cordless telecommunications protocol is a DECT (Digital Enhanced Cordless Telecommunications) protocol.

10. The cordless phone system according to claim 1, wherein said processing means comprises a processing unit of a wireless network communication module comprising said wireless network communication interface, and a processing unit of a cordless telecommunication module comprising said cordless-telecommunications communication interface.

11. The cordless phone system according to claim 1, wherein said processing means comprises one or more processors.

12. A method of data communication for a cordless phone system having a phone base apparatus comprising a PSTN communication interface, a wireless network communication interface, and a cordless-telecommunications communication interface and a handset apparatus comprising a user interface, said method comprising the steps of:
receiving, at said phone base apparatus, data through said wireless network communication interface via a wireless network;
processing, at said phone base apparatus, said received data for rendering at said handset apparatus;
transmitting said converted data from said cordless-telecommunications communication interface of said phone base apparatus to said handset apparatus; and
rendering, at said handset apparatus, said transmitted data and outputting said rendered data from said user interface.

13. The method of claim 12, further comprising the steps of:
receiving, at said handset apparatus, a control command for retrieving data from a remote source accessible from said wireless network via the wireless network communication interface and said cordless-telecommunications communication interface of said phone base apparatus; and
forwarding said control command from said handset apparatus to said phone base apparatus.

14. The method of claim 12, wherein said phone base apparatus is adopted to convert data received by said wireless network communication interface to a format suitable for a user interface of said phone base apparatus or a user interface of said handset apparatus.

15. The method of claim 12, wherein said conversion of said received data for rendering at said handset apparatus is performed by downsizing said received data to a size suitable for rendering at said handset apparatus.

16. The method of claim 12, further comprising the steps of detecting a request for an incoming or an outgoing call through said PSTN communication interface while performing communication using said wireless network communication interface.

17. The method of claim 16, further comprising the step of stopping or pausing said communication using said wireless network communication interface when said request is detected.

18. The method of claim 12, wherein said wireless network communication interface communicates using at least one of a wireless local area network (WLAN) protocol, a Bluetooth protocol and an IrDA protocol.

19. The method of claim 12 wherein said cordless-telecommunications communication interface communicates using a DECT (Digital Enhanced Cordless Telecommunications) protocol.
